(19) United States
(12) Patent Application Publication
(10) Pub. No.: US 2007/0182663 A1
(43) Pub. Date: Aug. 9, 2007

(54) Portable, folding and separable multi-display computing system

(76) Inventor: Grant Steven Biech, Langley (CA)

Correspondence Address: GOTTLIEB RACKMAN & REISMAN PC, 270 MADISON AVENUE, 8TH FLOOR, NEW YORK, NY, 100160601, US

(21) Appl. No.: 11/628,430

(22) PCT Filed: Jun. 1, 2005
(86) PCT No.: PCT/CA05/00831

§ 371 Date: Feb. 21, 2007

Related U.S. Application Data
(60) Provisional application No. 60/575,428, filed on Jun. 1, 2004.

(51) Int. Cl. G09G 5/00

(52) U.S. Cl. 345/1.1

(57) ABSTRACT

The present invention provides a coupling mechanism between a primary computing device and a secondary computing device, wherein each computing device may be physically separated from each other while continuing to communicate with each other. The primary computing device has the minimum functionality of a complete computing system such as a Tablet PC™, for example, and the secondary computing device has the minimum functionality of a hand-held computer monitor. The secondary computing device may also however, have the functionality of a complete computing system, or other level of functionality therebetween. The primary computing device may act as a master and control the functionality of the secondary computing device via a network or data bus connection, for example. The secondary computing device may be toggled between computer monitor functionality and secondary computer functionality regardless of whether or not the two computers are physically connected.

### FIELD OF THE INVENTION

The present invention pertains to the field of portable computer systems. More specifically, the present invention relates to a computer system with the ability to fold and separate portions thereof.

### BACKGROUND

Personal computer systems generally utilize a single screen for the display of graphics and/or data. The single screen is typically designed to provide adequate viewing by a single person. However, there are many instances, such as business conferences or instruction, where it is necessary that more than one person view the screen. In such instances the additional viewers generally view the display from an awkward angle such as from behind or to the side of another viewer. Additional viewers may therefore have an obstructed or uncomfortable view of the display. To allow for easier viewing of the screen in instances where there are multiple viewers many multiple screen computers have been developed. For example, U.S. Pat. No. 6,667,877 discloses a dual display device with lateral withdrawal for side-by-side viewing and U.S. Pat. No. 6,532,146 discloses a computer display with multiple lateral slide-out screens.

Having multiple screens in a portable computer system can become cumbersome to handle therefore most dual screen portable computers are foldable for convenience and ease of storage and transportation. For example, U.S. Pat. No. 6,667,878 discloses a dual screen computer in which the two screens are mechanically coupled to each other and to the computer in a manner that allows the three elements to be collapsed into a compact unit. A cover is provided to protect the second screen and the cover functions as the top of the computer when the unit is collapsed. In addition, the two screens are able to display identical images at the same time. Multiple users are thus able to obtain a better view of the material being displayed.

In addition, U.S. Pat. No. 6,094,341 describes a notebook computer with a folded dual-display wherein the computer body is pivoted with a first display and the first display is pivoted with a second display thus allowing the first and second displays to be folded. Again, this allows multiple viewers to view the display simultaneously.

To further improve the visibility of multiple screens, U.S. Pat. No. 6,643,124 discloses a multi-display, portable computing device in which the display panels are able to rotate as well as slide with respect to one another thus providing an expanded configuration that allows improved viewing.

The bulk of portable computer systems has also been reduced by replacing keyboards with touch sensitive screens as the input device such as in Tablet PCs™. U.S. Pat. No. 5,847,698 discloses an electronic book device with an electronic display unit having a flat panel screen and a housing for containing the flat panel screen. A cover is provided, which is hingedly and electrically connected to the electronic display unit. The housing further has a means for accessing material on a PC card and forwarding the material to the electronic display unit. The data entry mechanism can be implemented by using a touchscreen for the electronic display unit and the cover can be replaced with a second electronic display thus forming a dual-screen device.

U.S. Pat. No. 5,761,485 provides an electronic book comprising two display sections hinged together such that they can be opened and closed like a book. This invention replaces a handheld book with an electronic equivalent that is sized and configured to resemble a book. When opened, the user sees two facing page-like touch-sensitive, display screens with black print on white background. U.S. Pat. No. 6,313,828 also discloses a similar electronic book system.

U.S. Pat. No. 6,700,733 discloses a portable computer system that provides flexibility between using various components of the system with unused parts being conveniently folded away. In a first mode, the computer is in an open configuration that corresponds to a typical open configuration for a notebook computer, wherein the display and the alphanumeric keyboard are accessible to the user. In a second mode, the computer is in an open configuration wherein the display and the keyless input device (e.g., the digitizer) are both accessible to the user, while the keyboard is disposed under the keyless input device or is otherwise inaccessible. In a third mode, the computer is in a tablet configuration wherein the display is exposed and accessible for data input, while the other keyless user interface and keyboard are disposed under the display or otherwise arranged in a stacked configuration so as not to increase the footprint of the computer significantly beyond that of the display.

Although the portability and visibility of computer display screens has been significantly improved by the implementation of additional screens and positioning systems, it is difficult for multiple people to work collaboratively using a single computer system where each user is individually able to perform computing functions on the same system. In addition, because the multiple screens are physically connected to each other, the comfort and viewing of the displays is still limited by the position of the main computing unit. There is therefore a need for a new portable computing system with multiple display screens.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a portable, folding and separable multi-display computing system. In accordance with an aspect of the present invention, there is provided a portable, foldable and separable multi-display electronic computing system comprising: a primary computing device including a first display; a secondary computing device including a second display; a coupling mechanism adapted for pivotally and separably connecting said primary computing device and said secondary computing device; and a communication means adapted for providing data transfer between said primary computing device and said secondary computing device, said communication means providing data transfer in connected and separated configurations of the primary computing device and secondary computing device.

### BRIEF DESCRIPTION OF THE FIGURES

FIG. 1 illustrates a multi-display computing device according to one embodiment of the present invention.

FIG. 2a illustrates an orientation of use of multi-display computing device according to one embodiment of the present invention referred to as a “laptop” orientation.

FIG. 2b illustrates an orientation of use of multi-display computing device according to one embodiment of the present invention referred to as a “portfolio” orientation.

FIG. 2c illustrates an orientation of use of multi-display computing device according to one embodiment of the present invention referred to as a “presentation” orientation.

FIG. 2d illustrates an orientation of use of multi-display computing device according to one embodiment of the present invention referred to as a “collaboration” orientation.

FIG. 3a illustrates a top view of a portion of a coupling mechanism according to one embodiment of the present invention.

FIG. 3b illustrates a cross-sectional view of a portion of a coupling mechanism according to one embodiment of the present invention.

### DETAILED DESCRIPTION OF THE INVENTION

Definitions

The term “physical communication means” is used to define a communication means in which data is transferred by means of a material other than air, such as a cable, wire or optical fibre, for example. The term is used to differentiate a hard-wired communication means from a wireless communication means.

Unless defined otherwise, all technical and scientific terms used herein have the same meaning as commonly understood by one of ordinary skill in the art to which this invention belongs.

The present invention provides a coupling mechanism between a primary computing device and a secondary computing device, wherein each computing device may be physically separated from each other while continuing to communicate with each other. The primary computing device has the minimum functionality of a complete computing system such as a Tablet PC™, for example, and the secondary computing device has the minimum functionality of a hand-held computer monitor. The secondary computing device may also however, have the functionality of a complete computing system, or other level of functionality therebetween. The primary computing device may act as a master and control the functionality of the secondary computing device via a network or data bus connection, for example. The secondary computing device may be toggled between computer monitor functionality and secondary computer functionality regardless of whether or not the two computers are physically connected.

The coupling mechanism allows each computing device to be mechanically separated from each other without the use of tools and further allows the computing devices to fold together forming a more compact portable unit. For example, the unit may fold together with the two display screens facing each other in the same manner as the closing of a book.

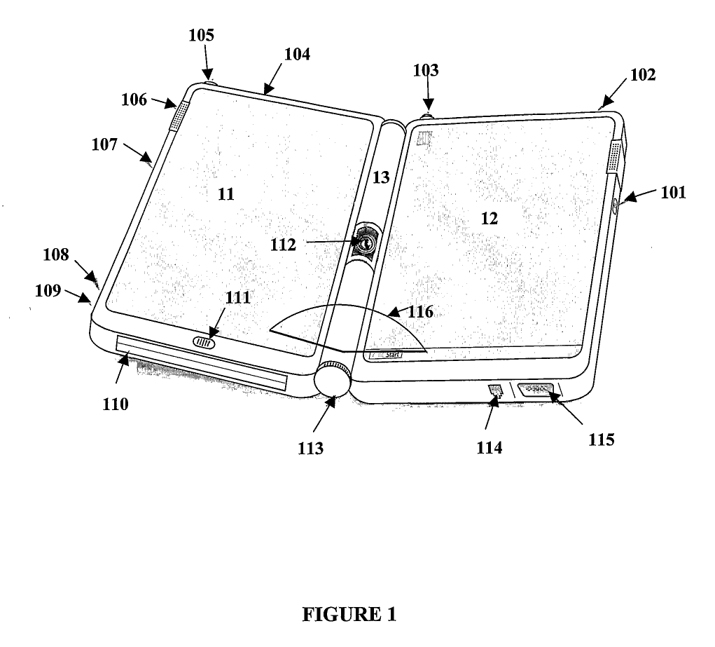

FIG. 1 illustrates multi-display computing device according to one embodiment of the present invention. In this embodiment, primary computing device 11 is connected to secondary computing device 12 via coupling mechanism 13.

Communication between the primary and secondary computing devices may occur by means of a physical connection such as a cable, for example, or a wireless connection via the use of wireless transceivers. Either of these communication means may be used when the computing devices are mechanically connected as well as when the devices are mechanically separated. In one embodiment of the present invention, the communication means is integrated with the coupling mechanism and facilitates direct communication between each of the computing devices of the invention.

The present invention further provides the ability to couple more than two computing devices wherein the computing devices are sequentially connected mechanically by means of a coupling mechanism between each computing device. Each computing device may have the ability to communicate with every other computing device in the system. Various folding configurations are also possible for collapsing multiple device systems. Systems with more than two computing devices may comprise multiple devices that can act as the primary computing device and may have multiple devices that can act as secondary computing devices. There will however typically be one computing device that functions as the primary computing device at any given time.

In one embodiment of the present invention, the coupling mechanism provides a virtually seamless connection between the display means of the computing devices such that when the computing devices are connected together the visual effect of a single display can be obtained. Therefore, this embodiment provides the advantage of being able to fold the computing devices into a compact unit as well as separate the devices while providing the visual effect of a single screen when the devices are connected.

In another embodiment of the present invention, the display means of the computing devices may be folded along an axis of the display.

Primary Computing Device

The primary computing device comprises the minimum functionality of a complete computing system such as a Tablet PC™, for example, as well as a means of communication with other computing devices that form the system of the present invention. A complete computing system is a system that comprises components that together are able to sufficiently perform general computing functions, as would be readily understood by a worker skilled in the art, and may have the capability to connect to external hardware and/or software. When a primary computing device is mechanically separated from a secondary computing device, the primary computing device retains its functionality and may control the secondary computing device. When multiple secondary computing devices are present, the primary computing device may control each individual secondary computing device.

The primary computing device includes data storage means, computer processing means, input and output means, power sources, display means, software, communication means with external devices and a housing or chassis. The system may further include networking means as well as other hardware and/or software components.

The data storage means may include dynamic data storage such as Random Access Memory (RAM), and static data storage such as one or more hard drives or one or more Flash Read Only Memories (ROMs) or a combination of hard drives and Flash ROMs. Additional hard drives may also be added to the primary computing device via AT-attached (ATA) and Small Computer System Interface (SCSI) hard drive bays and other bays as would be readily understood by a worker skilled in the art. The computer processing means can comprise one or more Central Processing Units (CPUs).

The display means is capable of displaying images compiled from data from one or more display adaptors. In one embodiment of the present invention the display means is a Low Voltage Differential Signal Liquid Crystal Display (LVDS LCD). In other embodiments the display means may be Cathode Ray Tube (CRT) or Flat Screen monitors. The display means may comprise internal video adaptors that support concurrent output to one or multiple display screens. In addition, the display means may support external video adaptors for single or multiple monitors connected to a port replicator, for example, and may support both internal and external video adaptors concurrently.

The display of the primary computing device can be of any size achievable by state of the art display technology. For example, the screen size may be greater than 16″ in diameter with a minimum width and length of 9½″ and 12½″ respectively. The display size may also have minimum dimensions of 7½″ by 9¼″ or 3″ by 4½″. When a primary computing device is coupled with a secondary computing device the visual effect of a single screen with the size being a combination of the two individual screens may be achieved. Various effective screen sizes may further be achieved with the combination of varying numbers and sizes of computing devices coupled together.

Other output devices, in addition to the display means, may include built-in stereo speakers, headphone output, and any other device that facilitates output from the primary computing device. In addition, the primary computing device may comprise one or more Video Graphics Array (VGA) ports for connection to external video devices such as monitors or projectors.

In one embodiment of the present invention, the display means provides a keyless input device such as a touch screen. The touch screen may use an analog resistive digitizer wherein the resistive digitizer comprises a normal glass panel that is covered with a conductive and a resistive metallic layer. These two layers are held apart by spacers and an electrical current runs through the two layers while the monitor is operational. When a user touches the screen, the two layers make contact and the change in the electrical field is used to determine the coordinates of the point of contact. The touch screen may optionally use an analog capacitive digitizer wherein a layer that stores electrical charge is placed on the glass panel of the monitor. When a user touches the monitor with a finger, for example, some of the charge is transferred to the user, thus decreasing the charge on the capacitive layer. This decrease can be measured and used to determine the point of contact on the screen. In addition, the touch screen may optionally use a surface acoustic wave system, wherein two transducers, namely a receiving and a sending transducer, are placed along the x and y axes of the monitor. Also placed on the glass are reflectors to reflect an electrical signal sent from one transducer to the other. The receiving transducer is able to detect whether the wave has been disturbed by a touch event at any instant, and can locate its position accordingly. Another type of digitizer that may optionally be used by the touch screen is an active or electromagnetic digitizer, wherein a special stylus is used to send a signal to the display indicating where the stylus is on the screen. Because of this digitizer's high resolution, handwriting recognition can be accurate. Unlike some of the other touch screen technologies, this digitizer makes it possible to rest your hand on the screen while writing. With the active digitizer, a battery may be required in order for the digitizer system to operate. Other forms of touch screens may also be used to enter data into the primary computing device as would be readily understood by a worker skilled in the art.

In one embodiment a standard QWERTY keyboard or a portion of a QWERTY keyboard may also be used as an input device for the primary computing device. The input device may additionally be a thumb keypad or a portion of a thumb keypad. In one embodiment, the keyboard/keypad may be removably connected to the primary computing device. Other input devices may be used such as microphones, cameras, CD/DVD drives or any other device that permits data to be entered into the primary computing device as would be know to a worker skilled in the art. In addition, the primary computing device may also comprise a built in stereo line.

Furthermore, input/output from the primary computing device may occur by means of one or more built-in Universal Serial Bus (USB) and FireWire ports, Accelerated Graphics Port (AGP) card slots, Secure Digital (SD) card ports, Bluetooth ports, optical ports, or infrared ports for example. Communication of the primary computing device with external electronic devices may include communication with port replicators, docking stations, Peripheral Component Interconnect (PCI) cards, Express cards and other computing systems, for example.

In one embodiment of the present invention, the primary computing device supports surprise docking and undocking of the device. This feature can essentially be the ability to connect and disconnect devices of the system to and from a docking station without the need to notify the system. Communication between the primary computing device and a docking station may occur via a FireWire or USB connection, for example. The docking station may further comprise a display stand for holding the primary computing device, or other devices of the system, in an approximately upright position thus allowing the computing device to be used in a similar manner as a desktop computing system, in particular when coupled to an external keyboard. In one embodiment of the present invention, a display stand may be used to support the computing device in an approximately upright position and adjustable as desired by the user.

The networking means may comprise one or more Network Interface Controllers (NICs) or an internal router, for example. Furthermore, the networking means may comprise Local Area Networking (LAN) technology such as Ethernet or Wireless LAN (WLAN). The primary computing device may also comprise RJ45 LAN and/or RJ11 phone connections.

The software of the primary computing device includes operating system software, driver software and program software, and may also include other software components. In addition, in one embodiment, the software can provide a quick security logon procedure by pressing a combination of keys on a keyboard or keypad. Furthermore, one embodiment comprises software that allows the secure capture of legally binding signatures via the display of the computing device. In one embodiment the operating system software may be Windows XP Professional™. In another embodiment the operating system may be Windows XP Tablet PC Edition™. or other suitable operating systems (OS) as would be readily known by a worker skilled in the art.

In one embodiment some of the software that supports the separability of the primary computing device from the secondary computing device includes a Display Docking Application, a User Generator Application, a User Manager Application, an Application Toolbar, and a Display Manager toolbar. The Display Docking Application can facilitate the docking and undocking of the secondary computing device by automating the display, application and user configuration changes required for this procedure. When secondary computing devices are physically attached to the primary computing device, the system of the present invention can function as a standard multi-display computer. When detached, secondary computing devices may function as thin clients or secondary computer monitors, for example. The advantage the thin client offers is that its user rights and permissions can be managed from the primary computing device. This feature can be used to manage the environment of the secondary computing device(s) (such as removing the toolbar) as well as preventing a secondary user from launching protected programs and documents or editing open documents. In addition, when two users are collaborating on a single document (such as a Microsoft Word document), this application can keep track of which user made which change. Furthermore, this application may have a one button Graphics User Interface (GUI) or hardware interface, such as a button, switch, dial or knob, for example, used to send the secondary computing device into thin client mode while still attached. This allows the primary computing device user to test settings and preview what the secondary user can experience when the displays are separated. The physical separation of a secondary computing device from a primary computing device may also trigger a particular secondary mode of operation.

For example, the User Generator Application can be an executable software component that generates custom “secondary computing device” users and user groups, and sets the rights, permissions and policies associated therewith. This application may have no interface other than a file icon that may be launched to run the program at anytime in order to overwrite any changes made since it was last run. This form of executable can create users and groups designed for use with secondary computing devices when functioning as thin clients, for example. It can also modify the user rights, permissions and policies associated with those users and groups it creates. This executable might only be run once when the operating system is first being installed.

For example, the User Manager Application software can provide a simple interface for modifying the rights, permissions and policies associated with managing the users of the secondary computing device when detached. This application may primarily be made up of Wizards and a GUI interface and can simplify the process of managing user access to secondary computing devices when in thin client mode, for example. The User Manager application can create and edit users and groups as well as manage their associated rights, permissions and policies.

For example, the Application Toolbar can provide a single toolbar that adds and/or simplifies functionality of applications when used in conjunction with detached secondary computing devices. This toolbar can sense open and active applications and display the open applications in a drop-down list for the primary computing device user to make selections from. In one embodiment this toolbar can offer duplicate image, duplicate document, lock-step, document permissions manager, and launch to secondary computing device functionality.

For example, with the duplicate image functionality, once a selection is made the user can choose to display a duplicate image of that application on a detached secondary computing device. This image may offer no functionality to the secondary computing device user. The duplicate image can be displayed in real-time so that any changes made to the original (such as scrolling down a page or editing) are reflected in the duplicate.

For example, with the duplicate document functionality, once a selection is made the user can choose to duplicate the open document onto the display of a secondary computing device (that is, automatically set the document protection to allow sharing and open the document on both displays). The permissions the secondary computing device user has for editing their copy of the open document can depend on the applications settings combined with the secondary computing device user's file permissions to that document.

In one embodiment once a duplicate document has been launched on the secondary computing device a lock-step functionality can be triggered by pressing a button, for example. This button can synchronize the two instances of the document so that whenever one user moves through their copy of the document, the other users document moves in synchronicity with it. The primary computing device user can choose who has control of moving through the document, for example.

In one embodiment, with the document permissions manager functionality, the document level permissions for common applications such as Microsoft Office and Adobe Acrobat may be revealed in a toolbar for easy access once the Duplicate Document button has been pressed and the application is active.

In one embodiment, the launch to secondary computing device functionality can also be activated by pressing a button, for example. This button can allow the primary computing device user to launch an instance of an application to the secondary computing device. For example, the primary computing device user can “give” the secondary user Internet Explorer to research something on the Internet.

In one embodiment, the Display Manager Toolbar can provide an application for managing what is being viewed on each display when separated. This toolbar can have several functions that offer forms of global control over the secondary computing device display from the primary computing device display, for example with the use of a turn on/off secondary computing device functionality, turn on/off secondary computing device screen functionality, secondary computing device preview functionality, and duplicate screen functionality.

In one embodiment, pressing a button for example can activate the turn on/off secondary computing device functionality. This button can power the secondary computing device on or off or put it in and out of Standby and Hibernate modes, for example. The turn on/off secondary computing device screen can also be activated by pressing a button for example. This button can turn the secondary computing device screen on and off to save power or get the secondary user to shift their attention away from the screen. Alternatively a screen saver can be initiated.

In one embodiment, with the secondary computing device preview functionality the entire contents of the detached secondary computing device screen can be viewed in a single, scalable, resizable window on the primary computing device display. This preview can be interactive and allow the primary computing device user to interact with it the same as if they were manipulating the secondary computing device directly.

In one embodiment, with the duplicate screen functionality the primary computing device user can create a duplicate image of their entire display and project it onto the secondary computing device screen much the same way as the Application Toolbar's Duplicate Image button functions, for example.

Furthermore, additional software and/or hardware may be used to control the orientation of the images displayed by the computing devices. For example, rotation of the image from a portrait view to a landscape view and vice versa can be achieved without restarting the system and with the push of a button or a touch on a screen, for example. In addition, the orientation of the images displayed may be adjusted based on the orientation of use of the computing system. For example, if the orientation of use of a primary computing device connected to a secondary device is such that the primary computing device display is facing a user on one side of a table, for example, and the secondary computing device display is facing a user on the opposite site of the table, the software can orientate the images such that each user is able to appropriately view the display image. Various display orientations may be possible depending on the orientation of the computing devices. The appropriate image may be triggered by a user via a software interface or a button, switch or dial for example. In addition, a configuration sensor(s) may be associated with the system such that it is able to sense the orientation of use, for example the orientation of the primary computing device to the secondary computing device. This configuration sensor can subsequently provide information to the system in order for the appropriate orientation of the images to be displayed by each computing device. The appropriate image adjustments may be made automatically or a prompt may be provided to the user of the system for confirmation of any display orientation changes. The configuration sensor(s) may include one or more radiation sensors, stress sensors and/or pressure sensors, for example. The configuration sensor(s) may be coupled to any part of the computing system such as the chassis of the computing devices or the coupling mechanism.

The power source may be internal and/or external to the primary computing device. For example, the power may come from an internal battery and/or an external AC/DC source. In one embodiment, the primary computing device has the ability to resume standby in a particular amount of time, for example 5 seconds. In addition, in one embodiment, the primary computing device has the ability to hibernate when the battery is low to avoid data loss when battery power diminishes.

In one embodiment, the primary computing device further comprises a cover, which may have a protective function or simply provide an aesthetic function. The cover may be made from various materials including leather, nylon, plastic, metal or any other type of material. Furthermore, the cover may have a soft shell or a hard shell. The cover may also be luminescent.

In one embodiment, the primary computing device further provides soft screen protectors, which can be protectors that provide a particular feeling to the display means of the computing device. For example, the feeling of writing on a pad of paper may be achieved when writing on a touch sensitive screen. Another example includes achieving a surface that simulates a computer keyboard when typing on a touch sensitive LCD screen's virtual keyboard.

FIG. 1 additionally illustrates various components of the computing systems according to one embodiment of the present invention. These include an on/off switch 101, a USB port 102, a stylus 103, removable/rechargeable battery 104, a voice/data/fax modem receiver 105, stereo speakers 106, an SD card port 107, a stereo headphone port 108, a phone headset port 109, a port replicator 110, a microphone 111, a camera 112, a camera rotator 113, an RJ45 port 114, and a VGA port 115.

In one embodiment, the primary computing device has a functionality similar to that of a Tablet PC™. Table 1 summarizes some of the system components and capabilities of a primary computing device according to one embodiment of the present invention. Table 2 summarizes other features of a primary computing device according to another embodiment of the invention.

TABLE 1

| SYSTEM COMPONENT | CAPABILTIES/FEATURES |
|---|---|
| Processor | 233 megahertz (MHz) to 300 MHz or |
| | higher processor clock speed |
| | Single or Dual processor system |
| | Intel Pentium/Celeron family or |
| | AMD K6/Athlon/Duron family, or |
| | compatible processor |
| RAM | 64 MB to 128 megabytes (MB) or higher |
| Available Hard Disk Space | 1.5 gigabytes (GB) |
| Video Adapter and Monitor | Super VGA (800 × 600) or higher |
| Resolution | |
| CD-ROM or DVD Drive | |
| Keyboard and Microsoft | |
| Mouse or compatible | |
| pointing device | |

TABLE 2

| FEATURES | COMPONENTS/CAPABILTIES |
|---|---|
| Internet Access | 14.4 kilobits per second (Kbps) or |
| | higher modem |
| | Internet access account |
| Networking Capabilities | Network adaptor |
| | Access to network infrastructure |
| Instant Messaging | Network access |
| | Instant messaging account |
| Voice-Conferencing | Network access |
| | Instant messaging account |
| | 33.6 Kbps or higher speed modem |
| Video-Conferencing | Network access |
| | Instant messaging account |
| | 33.6 Kbps or higher speed modem |
| | Video-conferencing camera |
| | Supporting operating system |
| Application Sharing | Network access |
| | Instant messaging account |
| | 33.6 Kbps or higher speed modem |
| | Supporting operating system |
| Remote Assistance | Network access |
| | Supporting operating system |
| Remote Desktop | Network access |
| | Supporting operating system |
| Sound | Sound card |
| | Speakers and/or headphones |
| DVD Video Playback | DVD drive |
| | DVD decoder card and/or DVD decoder |
| | software |
| | 8 MB of video RAM |
| Windows Movie Maker | Digital and/or analog video capture |
| | device |
| | 400 MHz or higher processor for digital |
| | video camera capture |

Secondary Computing Device

The secondary computing device can have similar components and functionality to the primary computing device including the ability to communicate with other computing devices of the system of the present invention. The secondary computing device may communicate with a primary computing device as well as other secondary computing devices that may be part of the system of the present invention. When mechanically separated from the primary computing device, the secondary computing device may retain its functionality. For example, if the secondary computing device has the functionality of a complete computing system it can retain this functionality however it may still be controllable by the primary computing device. In addition, when separated the secondary computing device may retain reduced functionality such as that of a display device. The secondary computing device may toggle between various levels of functionality both when mechanically coupled as well as separated from other computing devices.

The secondary computing device can also have the functionality of a thin client computing device. A thin client computing device is typically a device that functions with the support of another computing device and holds a minimal set of software and data locally. Most of the data and software is obtained from a supporting computing device via a connection between a thin client device and a supporting device. Generally, relatively little processing occurs on a thin client device however depending on the desired functionality there may be significant processing power and RAM available on a thin client device. There may also be a high bandwidth connection between a thin client and a supporting device. In addition, a thin client may or may not have a hard disk associated with it. Allowing the secondary computing device to be a thin client can dramatically decrease the cost and size of the device. In addition, it can allow one or more users to work individually with multiple devices on a common set of data and applications. In embodiments of the present invention, the supporting computing device may be the primary computing device or other secondary computing device with the capability of supporting the secondary computing device, which is in the format of a thin client.

The secondary computing device may also be a display device such as a hand-held monitor. Thus, when detached from the primary computing device, other users are simultaneously able to view images displayed by the primary computing device without the inconveniences associated with sharing a single display.

Coupling Mechanism

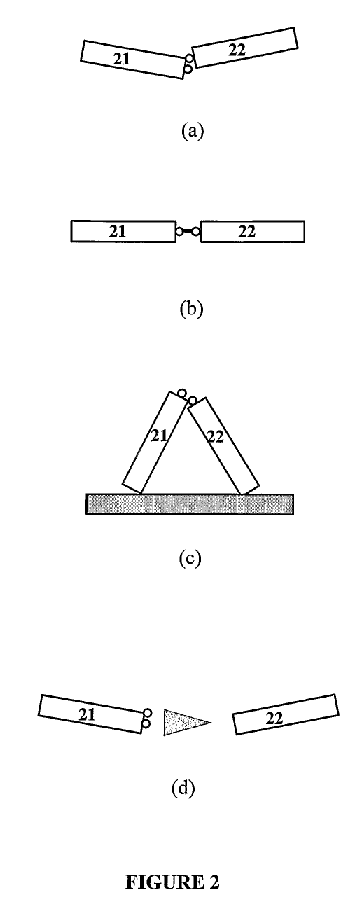

The coupling mechanism allows mechanical connection between any two computing devices and may be integrated into the housings of the computing devices. The coupling mechanism further allows the rotation of each computing device relative to the other such that any angle 116, as illustrated in FIG. 1, between 0 degrees and 360 degrees may be achieved. In addition, the coupling mechanism can allow the angle 116 to be maintained by a damping means. For example, two computing devices coupled together can therefore be rotated with their position maintained by the damping means such that the display screens of both devices face each other, or face outward and away from each other, as well as achieve any position in between. For example, as illustrated in the “laptop” orientation of use in FIG. 2a, one primary computing device 21 is coupled to one secondary computing device 22, and the system may be used with an angle 116 of less than 180 degrees between the two computing devices as a laptop would be used. The system may also be rotated into a “portfolio” orientation of use as illustrated in FIG. 2b in which the angle 116 is approximately 180 degrees and the system may be laid flat on a surface. In addition, the system may be used in a “presentation” orientation as illustrated in FIG. 2c in which the displays of each computing device 21 and 22 face outwards and the angle 116 is greater than 180 degrees. Use of the system in this configuration allows users on either side of a table for example to simultaneously view a display of the system. The coupling mechanism further allows separation of the computing devices. For example, the computing devices 21 and 22 can be mechanically separated by the coupling mechanism and used in a “collaboration” orientation as illustrated in FIG. 2d. In this orientation, the devices may communicate by wireless means.

The mechanical connection mechanism between two computing devices allows the joining and separation of the computing devices without the use of tools. In one embodiment, mechanical connection occurs by means of a hinging mechanism in which one side of the hinge comprises extrusions and the other side comprises corresponding intrusions, and a locking mechanism is further used to secure the two sides of the hinge together. Both sides of the hinge may however comprise both extrusions and intrusions. The locking mechanism may entail a sliding mechanism such that when the intrusions and extrusions of either side of the hinge are matched together, sliding the two sides relative to each other in a particular plane causes the hinge to be secured together while still allowing rotational movement between the devices. In addition, the locking mechanism may comprise an additional component, which may be external to the hinge or attached to a portion of the hinge, such as a clamp or a pin that may be inserted into the hinge to secure the two sides together. Other types of locking mechanisms may also be used including the use of magnets for example or others as would be known to a worker skilled in the art.

In another embodiment, one side of the hinging mechanism may comprise a component with a larger outer perimeter that slides over a component with a smaller inner perimeter. A third locking component may also be present to secure the previous two components together, again, while allowing rotation of the devices relative to each other.

In one embodiment the allowable rotation between two connected devices may be a full 360-degree rotation, however, this may be less in other embodiments depending on the type of connection mechanism used.

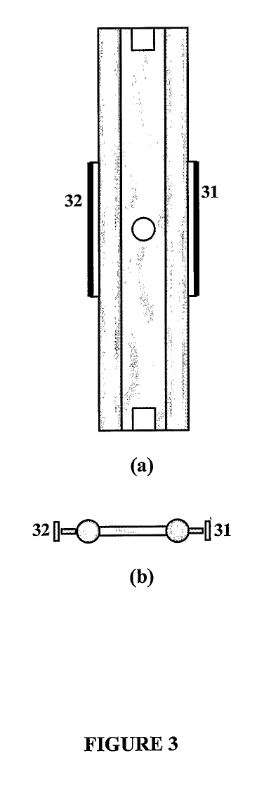

FIG. 3a illustrates the top view of a portion of a coupling mechanism according to one embodiment of the present invention and FIG. 3b illustrates a cross-sectional view of the embodiment of FIG. 3a. One computing device attaches to the protrusion 31 and another device attaches to the protrusion 32. A composite data bus that carries both video and input/output data is coupled to the protrusions 31 and 32 and interfaces with a similar data bus coupled to the respective computing device. The protrusions 31 and 32 can be pushed flush inside the hinge once the computing devices are detached so that they are stowed when the computing devices are separated.

In one embodiment, the coupling means comprises a damping means enabling retention of a desired orientation between the primary and secondary computing devices. For example, an elastic force from a tensile or compressive sleeve or other component may be used such that when a user rotates one computing device relative to the other, the tensile or compressive force is used to maintain the position of the two devices. A stretched or compressed spring, for example, may be used to provide this force. A frictional force may also be used to provide the damping means. For example, two surfaces in contact between the two sides of the hinging mechanism may be designed to provide a frictional force sufficient to maintain the position of each computing device when rotated relative to each other. An additional material such as plastic, or other materials, with various textures and compositions, may also be used in the hinging mechanism to provide a frictional force for support of the devices. The damping means may also be designed to support various sizes and weights of computing devices.

In one embodiment of the present invention, the damping means provides sufficient support for securing the folded position with an angle 116 of either 0 degrees or 360 degrees, such that the coupled unit may be transported and stored with both devices held securely in place. In another embodiment, there may be an additional latching mechanism between the two computing devices such that when the devices are connected by the coupling mechanism and folded with a rotational angle 116 of either 0 degrees or 360 degrees, the latching mechanism further secures the position of the devices for ease of transportation and storing.

The coupling mechanisms provided herein are examples of such mechanisms, however, it would be obvious to a person skilled in the art that other coupling mechanisms may be used to mechanically connect the computing devices and allow rotation of the devices relative to each other.

The coupling mechanism may be integrated into the housings of the computing devices or may be an attachment to the housing. For example, the coupling mechanism may be attached to the housing using screws, glue, or other attachment means. In addition, the communication means, described in more detail below, may be integrated into the coupling mechanism.

Inter-Device Communication Means

Communication between a primary computing device and a secondary computing may occur via a physical connection such as a cord, cable or wire between the two devices or may occur via a wireless communication means. A wireless communication means may be, for example, an IEEE 802 protocol or Bluetooth protocol for example, or any other wireless means that allows communication between computing devices.

In one embodiment, where one primary computing device and one secondary computing device are coupled together forming the system of the present invention, communication is via a direct physical connection between the two devices, for example by means of a cable or wire. Communication occurs via the physical connection both when the devices are mechanically connected by the coupling mechanism described above, as well as when they are separated. Thus, the two devices may be separated except for the presence of a physical communication connection between them. In this embodiment, the communication means may be integrated into the coupling mechanism or the computing device housings.

In another embodiment in which more than two computing devices are sequentially connected, physical communication means exist between each adjacent pair of devices. In this embodiment a primary computing device may communicate with all secondary computing devices of the system via other secondary computing device, for example, in a linearly networked fashion. In addition, each secondary computing device may have the ability to communicate with other secondary computing devices.

In one embodiment of the present invention, the physical communication means may be coiled or spring loaded such that, the two devices can be spatially separated with the coil or spring allowing extension of the cable, for example, between the two devices. When the devices are connected by the coupling mechanism, the coil or spring can return to a compressed state and may be designed to conveniently stow in the housing or within the coupling mechanism itself. In another embodiment of the present invention, the connecting cable, for example, may coil around an apparatus within the device such that when the computing devices are separated the cable is extracted from the device as required, as is seen with a measuring tape for example.

In another embodiment, communication between computing devices of the system occurs by a wireless means both when the devices are mechanically connected and separated by the coupling mechanism. The wireless transceivers may be integrated into the coupling mechanism or other part of the computing devices. In embodiments where there are more than two computing devices, the primary computing device may communicate with all the secondary computing devices that are part of the system of the present invention. In addition, the secondary computing devices may also communicate with each other.

In another embodiment, communication between the computing devices can occur via a physical communication means, such as a cable, when the computing devices are mechanically coupled by the coupling mechanism. However, when the computing devices are mechanically separated, communication between devices can occur by a wireless means. For example, in one embodiment, engaging the coupling mechanism additionally provides a contact between two parts of the physical communication means, thus activating this physical communication means. This contact can be achieved for all rotational positions of the computing devices relative to each other. When the coupling mechanism is disengaged, physical connection between the two parts of the physical communication means is lost and subsequently activates a wireless means of communication between the devices. The wireless communication means may also be activated by means of software or hardware such as a button or switch, for example.

### EXAMPLE 1

In one embodiment of the present invention, the computing system comprises two computing devices, one primary and one secondary, separably coupled together and may be used in a similar way as a large workstation computing system, and the computing devices may be connected to a docking station, for example. This embodiment of the present invention can be well suited for use by graphic artists, desktop publishers and audio engineers as well as gamers, for example. Selected physical features and software features of this embodiment are provided below.

Selected Physical Features

Large greater than 16″ display computing devices (minimum 9½″×12½″ each)
Each computing device has its own CPU allowing for dual-processing when the devices are attached.
When separated, each device is a fully functioning computer (i.e. RAM, hard drive, processor)
Large RAM capacity (more than 1 GB per display)
Built in:
   LAN (RJ45 port)
   2 additional USB ports on secondary computing device
   Express Card slot −68 mm
   DVD/CD-RW drive
   2nd headphone port on 2nd computing device (audio can be routed to both headsets simultaneously
   1 MIDI port per computing device
      Selected Software Features
Capture secure, legally binding signatures on display screen of either computing device.
Management of user rights/permissions for secondary computing device users.

### EXAMPLE 2

In another embodiment of the present invention, the computing system comprises two computing devices, one primary and one secondary, separably coupled together. This embodiment can be well suited for use by lawyers, financial managers, architects sales and marketing professionals and real estate agents, for example. Selected physical features and software features of this embodiment are provided below.

Selected Physical Features

Large 16″+ displays (minimum 9½″×12½″ each)
Built in:
   LAN (RJ45 port)
   wireless data/fax modem
   RJ11 port for data/fax modem
   3rd USB port
   Express Card slot −68 mm
   DVD/CD-RW drive
      Selected Software Features
Secure capture of legally binding signatures on display screen of either computing device.
Management of user rights/permissions for secondary computing device users.

### EXAMPLE 3

In another embodiment of the present invention, the computing system is a midsized system with two computing devices, one primary and one secondary, separably coupled together. This system can also be well suited for use by lawyers, financial managers, architects, sales and marketing professionals and real estate agents in addition to home users, for example. Selected physical features and software features of this embodiment are provided below.

Selected Physical Features

Minimum display size of (7½″×9¼″ each)
Built in:
   LAN (RJ45 port)
   wireless data/fax modem
   RJ11 port for data/fax modem
   Express Card slot −54 mm
      Selected Software Features
Secure capture of legally binding signatures on display screen of either computing device.
Management of user rights/permissions for secondary computing device users.

### EXAMPLE 4

In a further embodiment of the present invention, the computing system is a small or pocket-sized system comprising two computing devices, one primary and one secondary, separably coupled together. This system can be well suited for high-level executives, lawyers financial managers and home users for example, due to its convenient size. Selected physical features and software features of this embodiment are provided below.

Selected Physical Features

Minimum display size of (3″×4½″ each)
Built in:
   LAN (RJ45 port)
   wireless data/fax/voice modem (provides PCS cell. phone capabilities)
   CF and/or SD and/or Express card slot(s)
   Microphone
   Camera

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A portable, foldable and separable multi-display electronic computing system comprising:
a) a primary computing device including a first display;
b) a secondary computing device including a second display;
c) a coupling mechanism adapted for pivotally and separably connecting said primary computing device and said secondary computing device; and
d) a communication means adapted for providing data transfer between said primary computing device and said secondary computing device, said communication means providing data transfer in connected and separated configurations of the primary computing device and secondary computing device.

2. The multi-display electronic computing system according to claim 1, wherein the primary computing device functions as a complete computing system.

3. The multi-display electronic computing system according to claim 2, wherein the secondary computing device functions as a thin client.

4. The multi-display electronic computing system according to claim 2, wherein the secondary computing device functions as a complete computing system.

5. The multi-display electronic computing system according to claim 2, wherein the secondary computing device functions as a display device.

6. The multi-display electronic computing system according to any one of claims 2 to 5 wherein the primary computing device is a master device and the secondary computing device is a slave device.

7. The multi-display electronic computing system according to claim 1, wherein the communication means is a hardwired communication mechanism.

8. The multi-display electronic computing system according to claim 1, wherein the communication means is wireless communication mechanism.

9. The multi-display electronic computing system according to claim 1, wherein in a coupled configuration the primary computing device and secondary computing device communicate using a hardwired communication mechanism and in a decoupled configuration the primary computing device and secondary computing device communicate using a wireless communication mechanism.

10. The multi-display electronic computing system according to claim 9, wherein switching between the hardwired communication mechanism and the wireless communication mechanism occurs automatically.

11. The multi-display electronic computing system according to claim 9, wherein switching between the hardwired communication mechanism and the wireless communication mechanism is user initiated.

12. The multi-display electronic computing system according to claim 1, wherein the coupling mechanism is adapted to enable 360 degree relative rotation between the primary computing device and the secondary computing device.

13. The multi-display electronic computing system according to claim 1, wherein the coupling mechanism comprises a damping means for maintaining a desired orientation between the primary computing device and the secondary computing device when in a coupled configuration.

14. The multi-display electronic computing system according to claim 13, wherein the damping means is a tensile/compressive damping system or a frictional damping system.

15. The multi-display electronic computing system according to claim 1, wherein the communication means is integrated into the coupling mechanism.

16. The multi-display electronic computing system according to claim 1, wherein the secondary computing device includes a configuration sensor, wherein the configuration sensor is adapted to determine second display orientation, thereby enabling modification of image orientation displayed by the second display.

17. The multi-display electronic computing system according to claim 1, wherein the primary computing device includes a configuration sensor, wherein the configuration sensor is adapted to determine first display orientation, thereby enabling modification of image orientation displayed by the first display.

18. The multi-display electronic computing system according to claim 1, wherein in a coupled configuration, the coupling mechanism, the first display and the second display are adapted to provide a visual effect of a single display.

19. The multi-display electronic computing system according to claim 1, wherein one or more of the first display and the second display is a touch screen thereby enabling keyless entry.
